(19) United States
(12) Patent Application Publication
(10) Pub. No.: US 2016/0214458 A1
(43) Pub. Date: Jul. 28, 2016

(54) SYSTEM AND METHOD FOR MONITORING AND OXYGENATING AN AUTOMOBILE CABIN

(71) Applicant: HCL Technologies Ltd., Chennai (IN)

(72) Inventor: Rajiv Mohan Dhas, Chennai (IN)

(21) Appl. No.: 15/087,274

(22) Filed: Mar. 31, 2016

Related U.S. Application Data
(62) Division of application No. 13/869,366, filed on Apr. 24, 2013.

(30) Foreign Application Priority Data
Apr. 24, 2012 (IN) 1615/CHE/2012

(51) Int. Cl. B60H 1/00; B60K 35/00; G01S 19/13

(52) U.S. Cl. CPC B60H 1/00771; G01S 19/13; B60K 35/00

(57) ABSTRACT

A system for monitoring and oxygenating an automobile cabin includes at least one oxygen sensor adapted to determine oxygen level inside an automobile cabin, at least one infotainment system adapted to facilitate user of the system to select a required amount of oxygenation with in a preferred range of oxygenation, at least one oxygen producing unit configured to provide oxygen rich air into said automobile cabin and a control device adapted to regulate functioning of all other elements of the system. Further, the control device determines the preferred range of oxygenation based on the oxygen level inside an automobile cabin and regulates functioning of oxygen producing unit to provide the required amount of oxygenation.

### PRIORITY DETAILS

The present application claims priority from Indian Application Number 1615/CHE/2012, filed on 24 Apr. 2012, the disclosure of which is hereby incorporated by reference herein. The present application is also a divisional of U.S. application Ser. No. 13/869,366 filed on 24 Apr. 2013, the disclosure of which is hereby incorporated by reference herein.

### CROSS REFERENCE TO RELATED APPLICATIONS

The present application is a divisional patent application of application Ser. No. 13/869,366 titled “System and method for monitoring and oxygenating an automobile cabin”, filed on 24 Apr. 2013, the contents of which are incorporated herein by reference.

### FIELD OF INVENTION

The embodiments herein relate to a system and a method for oxygenating, and more particularly but not exclusively to a system and a method for monitoring and oxygenating an automobile cabin.

### BACKGROUND OF INVENTION

Oxygen is the most vital element for human life. About 90% of the metabolic energy production in a human body is created by oxygen. Every cell, tissue and function in our body requires oxygen, from our lungs and heart, to our bones and immune system. A growing number of researchers also agree that the best way to improve health is by providing optimum oxygenation of every cell. This reflects the oxygen's role as one of the most important nutrient for a human body. Every cell in our body requires oxygen to function, repair and restore.

Although, oxygen is considered to be the most abundant element on earth, researches held in recent past reveals that the level of oxygen in atmospheric air has fallen drastically ever since the industrial revolution. Further, various studies reveal that the atmospheric oxygen level before industrial revolution is measured twice as high as that of today. Core samples taken from ancient glaciers and polar caps also indicate that oxygen levels in water and the atmosphere have decreased substantially from ancient times to modern industrial era. The geologic data indicates that the approximate values of atmospheric oxygen is about 50% 1000 years ago, to 38% about 100 years ago, to 22% about 30 years ago, to as low as 17% in some urban areas today.

With industrial revolution, the number of vehicles/automobiles has also increased. Further, there is a high possibility that the increasing level of oxygen depletion might result in a shortage of oxygen in an automobile cabin. The shortage of oxygen in the automobile cabin is considered to be extremely dangerous, especially while a user/driver is driving a vehicle. Shortage of oxygen (which is known as hypoxia) in a cabin while a user/driver is driving a vehicle might result in feeling of nausea which reduces the degree of concentration of the driver. Further, the shortage of oxygen results in multiple health problems such as headache, fatigue, shortness of breath. In case of severe hypoxia, or hypoxia of very rapid onset, change in levels of consciousness, seizures, coma, and death are also possible.

Further, various studies reveal that American motorists spend an average of about 500 million hours in their cars commuting to and fro from work each week. Furthermore, studies also reveal that oxygen content in car drops down on prolonged usage. Further, oxygen is also absorbed by ‘baby seats’ which leads to hypoxia in babies. The extremes of age are usually easily affected by small changes from the optimal scenario.

At present, most common methods/devices used for preventing a person form above mentioned health problems that are caused because of hypoxia, is by oxygenating the person with CPR (Cardiopulmonary resuscitation), oxygen masks/prongs, intubation or by putting him on a ventilator. However, implementing above mentioned devices such as CPR and oxygen masks to the driver of a vehicle may distract the driver's usual viewpoints and his concentration, thereby making the conventional devices unsafe. Further, the conventional devices does not measure the amount of oxygen that exist in a automobile cabin, in most cases, all these process are used to treat the person after he has been affected by hypoxia. Further, in the conventional devices such as CPR and oxygen masks, the required level of oxygen is set manually, whereas in most cases, the driver of a vehicle might not be aware of the required level of oxygen. Furthermore, the conventional devices do not network the oxygen regulation data which could be used for future references.

Further, oxygen level in air varies from place to place. The variation in oxygen level is because of various factors such as geographical altitude, air pollution and so on. For example, a driver of the automobile can experience a reduction in oxygen level inside the automobile cabin the level when he drives the vehicle to a place which is more polluted from a place which is less polluted. Similarly, a driver can experience a reduction in oxygen level while he drives up a hill because of variation in oxygen level with respect to geographical altitude. The conventional devices for preventing a person/driver form hypoxia do not evaluate and provide information regarding the oxygen level that varies with the geographical conditions thereby making the devices partially inefficient in preventing the driver from possible effect of hypoxia.

Therefore, there is a need for a system and a method to measure and oxygenate the incoming air to the automobile cabin and also to obviate the above mentioned drawbacks.

### OBJECT OF INVENTION

The principal object of this invention is to provide a system and a method to measure the oxygen content inside an automobile cabin.

Another object of the invention is to provide a system and a method to oxygenate the air circulating inside the automobile cabin, within a healthy/prescribed range.

Another object of the invention is to provide a system and a method to oxygenate the air circulating inside the automobile cabin automatically, within a healthy/prescribed range.

Yet another object of the invention is to provide a system and a method to measure the oxygen content and oxygenate the air circulating inside the automobile cabin, within a healthy/prescribed range.

A further object of the invention is to provide a system and a method to measure and oxygenate within a healthy/prescribed range the incoming air automatically into the automobile cabin that could detect the variation of oxygen level with respect to the geographical conditions and provide recommendations to the driver accordingly.

These and other objects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 depicts a system for measuring and oxygenating the air circulating inside an automobile cabin according to an embodiment disclosed herein;

FIG. 1a depicts a system for measuring and oxygenating the air circulating inside an automobile cabin coupled with a Global Positioning System according to an alternative embodiment disclosed herein;

FIG. 2 is a flow chart depicting the method for monitoring and oxygenating an automobile cabin according to an embodiment disclosed herein; and

FIG. 3 is a flow chart depicting the method for monitoring and oxygenating an automobile cabin automatically according to an embodiment disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

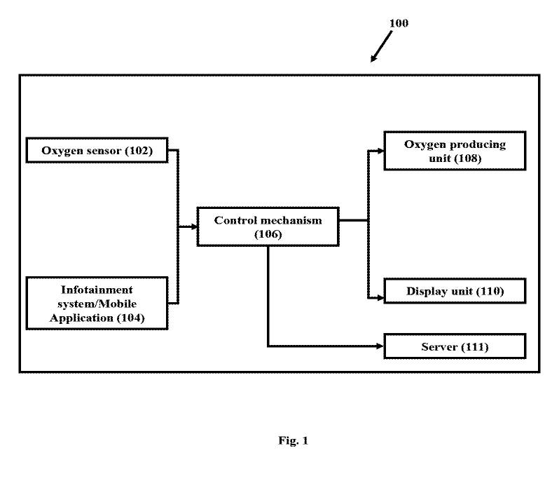

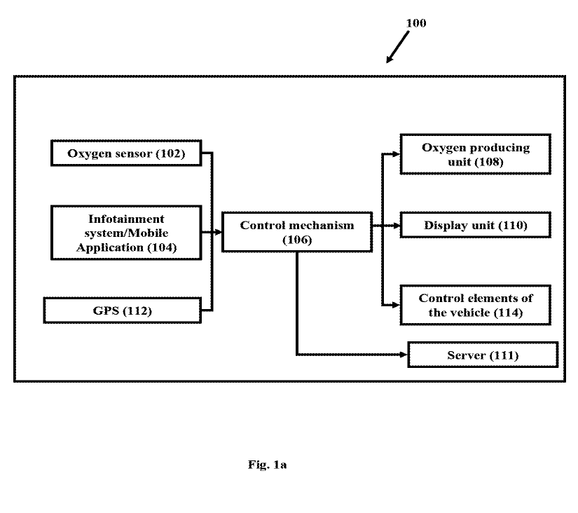

The embodiments herein achieve a system for measuring and oxygenating the air circulating inside an automobile cabin as described herein below. Referring now to the drawings, and more particularly to FIGS. 1 through 3, where similar reference characters denote corresponding features consistently throughout the figures, there are shown embodiments.

FIG. 1 depicts a system 100 for measuring and oxygenating the air circulating inside an automobile cabin according to an embodiment as disclosed. The system 100 includes an oxygen sensor 102, an infotainment system 104, a control mechanism 106, an oxygen producing unit 108, a display unit 110 and a server 111. The oxygen sensor 102 is configured to measure the level of oxygen content in the automobile cabin communicate with the control mechanism 106. In one embodiment, the oxygen sensor 102 is selected from a group that includes but not limited to capillary type sensors and diffusion type sensors.

The infotainment system 104 is provided in communication with the control mechanism 106 and configured to facilitate user of system 100 to select the amount of oxygenation required. In an embodiment, the infotainment system 104 is selected from the infotainment system for automobiles available in market. In another embodiment, the infotainment system is selected from the systems that facilitate at least one of managing and playing audio content, utilizing navigation for driving, delivering rear-seat entertainment such as movies, games and social networking, listening to incoming and sending outgoing SMS text messages, making phone calls, and accessing Internet-enabled or smart phone-enabled content such as traffic conditions, sports scores and weather forecasts. In another embodiment, the infotainment system 104 is further configured to facilitate user to select the fragrance of choice along with the amount of oxygenation required.

Further, the infotainment system 104 is configured to allow the user to select the amount of oxygenation required within a prescribed amount, thereby preventing oxygen intoxication. In one embodiment, the infotainment system 104 is replaced by a mobile application that is configured to allow the user to select the amount of oxygenation required with in a prescribed amount. The control mechanism 106 is provided in communication with all the other components of system 100 and configured to regulate the functioning of various electro-mechanical components included in the system 100. In an embodiment, the control mechanism 106 includes a processor core, a memory and programmable input/output peripherals. The input peripheral is provided in communication with oxygen sensor 102 and the infotainment system or mobile application 104. Further, the output peripheral of the control mechanism is provided in communication with the oxygen producing unit 106, the display unit 110 and the server 111.

The processor core of control mechanism 106 is configured to receive information from oxygen sensor 102 regarding the oxygen content available in the automobile cabin and display information regarding the oxygen content available in automobile cabin to the user of system 100 via the display system 110. In an embodiment, the display system 110 is the infotainment system 104. In another embodiment, the display system is selected from any device that could provide audio or video signals to the user.

Further, the processor core of control mechanism 106 is configured to receive information regarding the amount of oxygenation preferred by the user from infotainment system or mobile application 104 via the input peripheral of control mechanism 106 and regulate the functioning of oxygen producing unit 108 according to the amount of oxygenation required. In an embodiment, the processor core of control mechanism 106 is programmed to regulate the functioning of oxygen producing unit 108 automatically based upon the information obtained from oxygen sensor 102, regarding oxygen content available in the automobile cabin, so that the oxygen intoxication can be prevented.

The oxygen producing unit 108 is configured to produce or concentrate the oxygen in air. In an embodiment, the oxygen producing unit 108 is selected from the group that include, but are not limited to photo catalysis based oxygen producing unit, Nitrogen/Oxygen separation based oxygen producing unit and so on. However, it is also with in the scope of invention that the oxygen producing unit may be selected from any other devices without otherwise deterring the intended function of the oxygen producing unit 108 as can be deduced from this description. In one embodiment, the oxygen producing unit 108 is provided in communication with an A/C blower, such that the oxygen produced in the oxygen producing unit 108 is supplied to the automobile cabin via the A/C blower. However, it is also with in the scope of invention that the oxygen producing unit 108 may be provided as a separate unit which is configured to supply air into the automobile cabin. Further, the information such as the oxygen content available in the automobile cabin before oxygenating, selected amount of oxygenation required and the amount of oxygen content in the automobile cabin after oxygenating are stored in the memory of control mechanism 106. Further, the control mechanism 106 is configured to transfer the information to the server 111. The server 111 is configured to network the information which could be used to build databases for research purposes. The processor core of control mechanism 106 is configured to receive information from oxygen sensor 102 regarding the oxygen content available in the automobile cabin and process the received information to determine the prescribed amount of oxygenation required. Further, the prescribed amount of oxygenation required is displayed in at least one of display system 110 and infotainment system 104. Further, in an embodiment, the processor core of control mechanism 106 is configured to display the fragrance of choice in at least one of display system 110 and infotainment system 104.

It should be noted that the aforementioned configuration of system 100 is provided for the ease of understanding of the embodiments of the invention. However, certain embodiments may have a different configuration of the components of the system 100 and certain other embodiments may exclude certain components of the system 100. For example, a control mechanism 106 may include any other hardware device, combination of hardware devices, software devices or combination of hardware or software devices that could achieve one or more process discussed herein. Therefore, such embodiments and any modification by addition or exclusion of certain components of the system 100 without otherwise deterring the intended function of the system 100 as is apparent from this description and drawings are also within the scope of this invention.

In another embodiment, the system 100 further includes a Global Positioning System (GPS) 112 (as shown in FIG. 1a). The GPS system 112 is provided in communication with the control mechanism 106. The GPS system 112 is configured to provide location based information to the control mechanism 106 which in turn alerts the user regarding the atmospheric condition of the corresponding location. In one embodiment, the location based awareness is the pollution level corresponding to that location. In another embodiment, the location based awareness is the geographical altitude corresponding to that location. However, it is also with in the scope of invention, that the control mechanism 106 could provide any information with respect to the location that could affect the oxygen level. The control mechanism 106 is further configured to oxygenate the automobile cabin automatically based on information regarding the amount of oxygen content in the automobile and the atmospheric conditions obtained from location based information. In an embodiment, the control mechanism 106 is configured to regulate the functioning of various control elements of the automobile 114 (for example, recirculation of air). For example, when the automobile enters the location of high pollution level, the control mechanism 106 determines the pollution level of that location by the information from GPS 112 and server 111, and instructs the user to shut windows or put air in recirculation. Further, the control mechanism 106 automatically instructs the oxygen producing unit 110 to oxygenate the automobile cabin, in order to provide the optimal condition.

In an embodiment, the GPS system 112 is provided as an integral element of infotainment system or mobile application 104, thereby facilitating the control mechanism 106 to receive location based information from the infotainment system or mobile application 104.

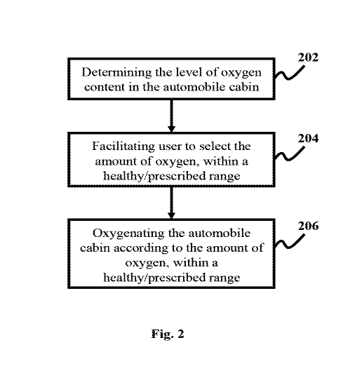

The method for monitoring and oxygenating an automobile cabin using system 100 is explained herein below. FIG. 2 is a flow chart depicting the method for monitoring and oxygenating an automobile cabin according to an embodiment disclosed herein. The method includes determining the amount of oxygen content available in the air inside automobile cabin, by oxygen sensor 102 (Step 202). Further, the user is allowed to select the amount of oxygenation required, through the infotainment system or mobile applications 104 (Step 204). In one embodiment, the information obtained from the oxygen sensor 102 is utilized by the control mechanism 106 to predefine a prescribed range of oxygenation in the display unit 110. Further, the user is allowed to define the amount of oxygenation within the prescribed range, in order to prevent oxygen intoxication. Further, the control mechanism 106 regulate the functioning of oxygen producing unit 108 in order to provide oxygen rich air corresponding to the amount of oxygenation defined by the user, to the automobile cabin (Step 206). In an embodiment, the oxygen producing unit 108 supplies the oxygen rich air to the automobile cabin through the A/C blower (not shown). In an embodiment, the user is allowed to select the fragrance desired along with the amount of oxygenation required.

It should be noted that the aforementioned steps for monitoring and oxygenating an automobile cabin are provided for the ease of understanding of the embodiments of the invention. However, various steps provided in the above method may be performed in the order presented, in a different order, or simultaneously. Further, in some embodiments, one or more steps listed in the above method may be omitted. Therefore, such embodiments and any modification that is apparent from this description and drawings are also within the scope of this invention.

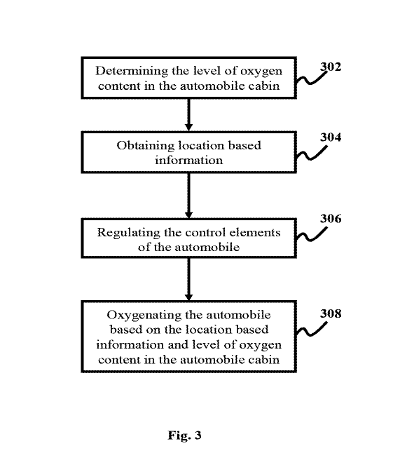

FIG. 3 is a flow chart depicting the method for monitoring and oxygenating an automobile cabin according to an embodiment disclosed herein. In another embodiment, control mechanism 106 is configured to automatically oxygenate the automobile content. The method includes determining the amount of oxygen content available in the air inside automobile cabin, by oxygen sensor 102 (Step 302). Further, the control mechanism 106 receives location based information from the GPS system 112. In one embodiment, the GPS system 112 could be provided as an integral element of the infotainment system or mobile application 104 (Step 304). Further, the control mechanism 106 receives the atmospheric condition corresponding to the determined location from the server 111. Further, based on the information obtained from the server 111, the control mechanism provides the important location based awareness to the user through the display unit 110. In one embodiment, the location based awareness is the pollution level corresponding to that location. In another embodiment, the location based awareness in the geographical altitude corresponding to that location. However, it is also with in the scope of invention, that the control mechanism 106 could provide any information with respect to the location that could affect the oxygen level.

Further, based on the location based information, the control mechanism 106 provides various alerts to the user in order to avoid oxygen intoxication. In one embodiment, the control mechanism 106 is configured to regulate the control elements of the car based on the location based information, in order to avoid oxygen intoxication (Step 306). Furthermore, based on the location based information and the determined level of oxygen content inside the automobile cabin, the control mechanism 106 regulates the functioning of oxygen producing unit 108, to prevent oxygen intoxication, by oxygenating the automobile cabin (Step 308). For example, when the automobile enters the location of high pollution level, the control mechanism 106 determines the pollution level of that location by the information from GPS 112 and server 111, and instructs the user to shut windows or put air in recirculation. Further, the control mechanism 106 automatically instructs the oxygen producing unit 110 to oxygenate the automobile cabin, in order to provide the optimal condition. In an embodiment, the oxygen producing unit 108 supplies the oxygen rich air to the automobile cabin through the A/C blower (not shown). In an embodiment, the user is allowed to select the fragrance desired along with the amount of oxygenation required. In another embodiment, the control mechanism 106 selects the fragrance based on the location based information.

Further, the information such as the oxygen content available in the automobile cabin before oxygenating, selected amount of oxygenation required and the amount of oxygen content in the automobile cabin after oxygenating are stored in the memory of control mechanism 106. Further, the control mechanism 106 transfers the information to the server 111 where the information is networked so that it could be used to build databases for research purposes.

It should be noted that the aforementioned steps for monitoring and oxygenating an automobile cabin are provided for the ease of understanding of the embodiments of the invention. However, various steps provided in the above method may be performed in the order presented, in a different order, or simultaneously. Further, in some embodiments, one or more steps listed in the above method may be omitted. Therefore, such embodiments and any modification that is apparent from this description and drawings are also within the scope of this invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A system for monitoring and oxygenating an automobile cabin, said system comprising:
at least one oxygen sensor adapted to determine oxygen level inside an automobile cabin;
a geographical positioning system (GPS) adapted to provide location based information;
at least one infotainment system configured to display location based awareness to a user of the system;
at least one oxygen producing unit configured to provide oxygen rich air into said automobile cabin; and
a control device provided in communication with said oxygen producing unit, said infotainment system, said geographical positioning system and said oxygen sensor, wherein
said control device is adapted to regulate functioning of said oxygen producing unit to provide said required amount of oxygenation automatically based on said location based information and said determined oxygen level inside said automobile cabin.

2. The system as claimed in claim 4, wherein said geographical positioning system is provided as an integral part of an infotainment system.

3. The system as claimed in claim 4 further includes a server provided in communication with the control system, wherein said server is configured to provide information on the required amount of oxygenation for a corresponding location.

4. A method for monitoring and oxygenating an automobile cabin, said method comprising:
determining oxygen level inside an automobile cabin;
obtaining location based information;
providing location based awareness to user of the system; and
oxygenating said automobile cabin based on said oxygen level inside the automobile cabin and said location based information.

5. A method as claimed in claim 9, wherein a location based information is provided by a geographical positioning system.

6. A method as claimed in claim 9, wherein said method further comprises of networking at least one of said oxygen level inside an automobile cabin, location based awareness and location based information.
